(19) United States
(12) Patent Application Publication
(10) Pub. No.: US 2012/0163277 A1
(43) Pub. Date: Jun. 28, 2012

(54) METHOD AND APPARATUS FOR ESTABLISHING MULICAST CONNECTION

(75) Inventors: Eunkyung KIM, Daejeon (KR); Sung Kyung Kim, Daejeon (KR); Sung Cheol Chang, Daejeon (KR); Won-Ik Kim, Daejeon (KR); Mi-Young Yun, Daejeon (KR); Hyun Lee, Daejeon (KR); Chul Sik Yoon, Daejeon (KR); Kwang Jae Lim, Daejeon (KR)

(73) Assignee: ELECTRONICS AND TELECOMMUNICATIONS RESEARCH INSTITUTE, Daejeon (KR)

(21) Appl. No.: 13/336,861

(22) Filed: Dec. 23, 2011

(30) Foreign Application Priority Data
Dec. 24, 2010 (KR) 10-2010-0134914
Mar. 4, 2011 (KR) 10-2011-0019653
Jul. 11, 2011 (KR) 10-2011-0068535
Oct. 31, 2011 (KR) 10-2011-0112476
Nov. 3, 2011 (KR) 10-2011-0113914
Dec. 23, 2011 (KR) 10-2011-0141346

(51) Int. Cl. H04W 4/06

(52) U.S. Cl. 370/312

(57) ABSTRACT

A method of establishing a multicast connection is provided. A mobile station transmits a registration request message for a discovery of a multicast service to the base station, and receives a registration response message from the base station in response to the registration request message. The mobile station exchanges a DSA request message and a DSA response message to the DSA request message with the base station, for a multicast connection on the multicast service. The mobile station receives a downlink control channel including allocation information of multicast resource from the base station.

### CROSS-REFERENCE TO RELATED APPLICATION

This application claims priority to and the benefit of Korean Patent Application Nos. 10-2010-0134914, 10-2011-0019653, 10-2011-0068535, 10-2011-0112476, 10-2011-0113914, and 10-2011-0141346 filed in the Korean Intellectual Property Office on Dec. 24, 2010, Mar. 4, 2011, Jul. 11, 2011, Oct. 31, 2011, Nov. 3, 2011, and Dec. 23, 2011, respectively, the entire contents of which are incorporated herein by reference.

### BACKGROUND OF THE INVENTION

(a) Field of the Invention

The present invention generally relates to a method and apparatus for establishing a multicast connection.

(b) Description of the Related Art

A multicast communication is used to a group communication where a plurality of users join in a conversation. In the group communication, the same downlink traffic is simultaneously transmitted to all the users in a group for the group communication. Therefore, the users joining the group communication use a multicast connection to transmit data of the group communication.

A connection establishment for a broadcast service such as a multicast broadcast service (MBS) is only defined as a conventional multicast connection establishment. However, since the MBS connection establishment cannot be applicable to a multicast communication for the group communication, new connection establishment for the multicast communication is required.

### SUMMARY OF THE INVENTION

Embodiments of the present invention provide a multicast connection establishment method and apparatus for supporting a multicast communication.

According to one embodiment of the present invention, a method of establishing a multicast connection with a base station is provided in a mobile station. The method includes transmitting a registration request message for a discovery of a multicast service to the base station, receiving a registration response message from the base station in response to the registration request message, exchanging a dynamic service addition (DSA) request message and a DSA response message to the DSA request message with the base station for a multicast connection on the multicast service, and receiving a downlink control channel including allocation information of multicast resource from the base station.

Each of the DSA request message and the DSA response message may include a multicast parameter. The multicast parameter may include a multicast group identifier (multicast group ID) to which a service flow on the multicast service is added and a flow ID (FID) for identifying the service flow in the multicast group.

The multicast parameter may further include a multicast group zone identifier (multicast group zone ID) where the service flow is valid. The multicast group zone may include a base station set including at least one base station, and each of the multicast group ID and the FID for the service flow may have the same value in the base station set.

The method may further include exchanging a dynamic service change (DSC) request message and a DSC response message to the DSC request message with the base station, for a change of the service flow. Each of the DSC request message and the DSC response message may include a new multicast group zone ID, current multicast group ID and FID, and new multicast group ID and FID.

Each of the DSA request message and the DSA response message may include a multicast parameter. The multicast parameter may include a multicast group connection identifier (CID) for identifying a service flow on the multicast service.

The multicast parameter may further include a multicast group zone ID where the service flow is valid. The multicast group zone may include a base station set including at least one base station, and the multicast group CID for the service flow may have the same value in the base station set.

The method may further include exchanging a DSC request message and a DSC response message to the DSC request message with the base station, for a change of the service flow. Each of the DSC request message and the DSC response message may include a new multicast group zone ID, a current multicast group CID, and a new multicast group CID.

Each of the DSA request message and the DSA response message may include a multicast service capability. The multicast service capability may indicate at least one of no available multicast service, a multicast in a serving base station only, or a multicast in a multi base station zone supporting.

Each of the registration request message and the registration response message may include a multicast service capability. The multicast service capability may indicate at least one of no available multicast service, a multicast in a serving base station only, or a multicast in a multi base station zone supporting.

According to another embodiment of the present invention, a method of establishing a multicast connection with a mobile station is provided in a base station. The method includes receiving a registration request message for a discovery of a multicast service from the mobile station, transmitting a registration response message to the mobile station in response to the registration request message, exchanging a DSA request message and a DSA response message to the DSA request message with the mobile station for a multicast connection on the multicast service, and transmitting a downlink control channel including allocation information of multicast resource to the mobile station.

Each of the DSA request message and the DSA response message may include a multicast parameter. The multicast parameter may include a multicast group ID to which a service flow on the multicast service is added and an FID for identifying the service flow in the multicast group.

The multicast parameter may further include a multicast group zone ID where the service flow is valid. The multicast group zone may include a base station set including at least one base station, and each of the multicast group ID and the FID for the service flow may have the same value in the base station set.

The method may further include exchanging a DSC request message and a DSC response message to the DSC request message with the base station, for a change of the service flow. Each of the DSC request message and the DSC response message may include a new multicast group zone ID, current multicast group ID and FID, and new multicast group ID and FID.

Each of the DSA request message and the DSA response message may include a multicast parameter. The multicast parameter may include a multicast group CID for identifying a service flow on the multicast service.

The multicast parameter may further include a multicast group zone ID where the service flow is valid. The multicast group zone may include a base station set including at least one base station, and the multicast group CID for the service flow may have the same value in the base station set.

The method may further include exchanging a DSC request message and a DSC response message to the DSC request message with the base station, for a change of the service flow. Each of the DSC request message and the DSC response message may include a new multicast group zone ID, a current multicast group CID, and a new multicast group CID.

Each of the DSA request message and the DSA response message may include a multicast service capability. The multicast service capability may indicate at least one of no available multicast service, a multicast in a serving base station only, or a multicast in a multi base station zone supporting.

Each of the registration request message and the registration response message may include a multicast service capability. The multicast service capability may indicate at least one of no available multicast service, a multicast in a serving base station only, or a multicast in a multi base station zone supporting.

According to yet another embodiment of the present invention, an apparatus for establishing a multicast connection is provided, and the apparatus includes a transceiver and a controller. The transceiver transmits a registration request message for a discovery of a multicast service to a base station, receives a registration response message from the base station in response to the registration request message, exchanges a DSA request message and a DSA response message to the DSA request message with the base station for a multicast connection on the multicast service, and receives a downlink control channel including allocation information of multicast resource from the base station. The controller generates the registration request message and the DSA request message or the DSA response message.

According to yet another embodiment of the present invention, an apparatus for establishing a multicast connection is provided, and the apparatus includes a transceiver and a controller. The transceiver receives a registration request message for a discovery of a multicast service from a mobile station, transmits a registration response message to the mobile station in response to the registration request message, exchanges a DSA request message and a DSA response message to the DSA request message with the mobile station, for a multicast connection on the multicast service, and transmits a downlink control channel including allocation information of multicast resource to the mobile station. The controller generates the registration response message and the DSA request message or the DSA response message.

### BRIEF DESCRIPTION OF THE DRAWINGS

FIG. 1 to FIG. 3 show a multicast communication system according to embodiments of the present invention.

FIG. 4 shows a multicast connection establishment method according to an embodiment of the present invention.

FIG. 5 shows a multicast resource allocation method according to an embodiment of the present invention.

FIG. 6 and FIG. 7 each are a block diagram of a multicast connection establishment apparatus according to an embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the term “mobile station (MS)” may designate a terminal, a mobile terminal (MT), an advanced mobile station (AMS), a high reliability mobile station (HR-MS), a subscriber station (SS), a portable subscriber station (PSS), an access terminal (AT), a user equipment (UE), and so on, or may include all or some functions thereof.

Further, the term “base station” (BS) may designate an advanced base station (ABS), a high reliability base station (HR-BS), a node B, an evolved node B (eNodeB), an access point (AP), a radio access station (RAS), a base transceiver station (BTS), an MMR (mobile multihop relay)-BS, a relay station (RS) performing base station function, a high reliability relay station (HR-RS) performing the base station function and so on, or may include all or some functions thereof.

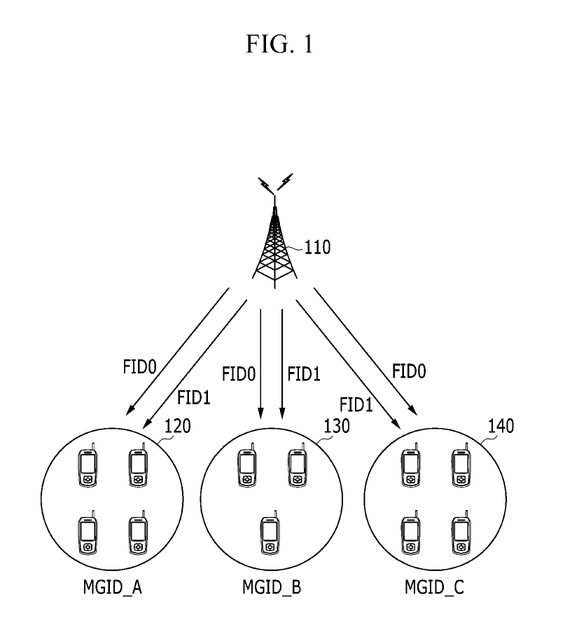

FIG. 1 shows a multicast communication system according to an embodiment of the present invention.

Referring to FIG. 1, a base station 110 uses a multicast group identifier (ID) allocated to a multicast group 120, to provide the multicast group 120 including a plurality of mobile stations with a multicast communication. The multicast group ID is uniquely allocated within the base station 110 and has a finite size. The multicast group ID is used as an ID for notifying the multicast group of the allocated resource. Other multicast groups 120, 130, and 140 have different multicast group ID MGID_A, MGID_B, and MGID_C.

The base station 110 uses a flow identifier (FID) for identifying a connection besides the multicast group ID. The base station 110 allocates the FID in each multicast group ID, thereby uniquely identifying the connection, i.e., a service flow within the multicast group. Since the FID is an ID for identifying a signal or traffic connection within the multicast group, a particular connection of the multicast group can be identified a combination of the multicast group ID and FID in the base station 110.

That is, the base station 110 uses the multicast group ID and the FID to provide the multicast group 120 with a multicast service. The same FID (FID0 or FID 1) can be used in the other multicast groups 120, 130, and 140.

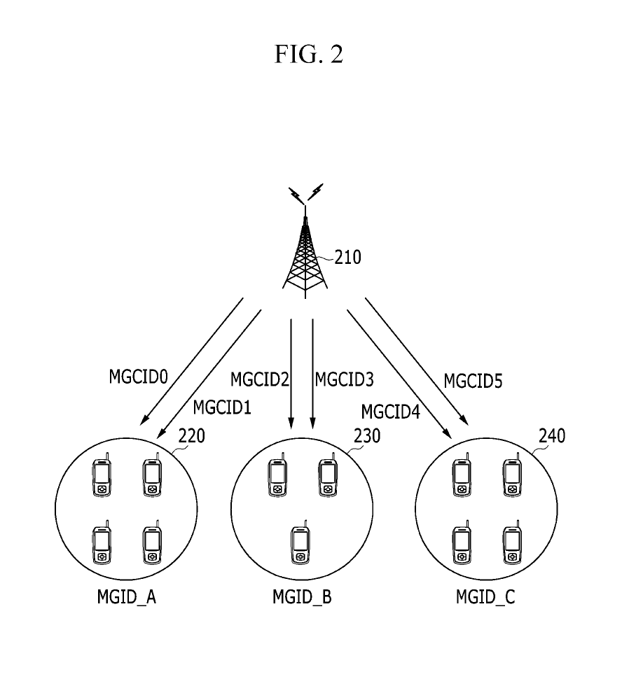

FIG. 2 shows a multicast communication system another embodiment of the present invention.

Referring to FIG. 2, a base station 210 uses a multicast group connection ID (CID) allocated to a multicast service, to provide a multicast group 120 including a plurality of mobile stations with the multicast service. The multicast group CID is uniquely allocated for identifying a connection (a service flow) within the base station 210 and has a finite size. Other multicast group CIDs (MGCID0, MGCID1, MGCID2, MGCID3, MGCID4, and MGCID5) are used in different multicast groups 220, 230, and 240. A multicast resource allocated to the multicast service can be notified to the multicast group through the multicast group CID.

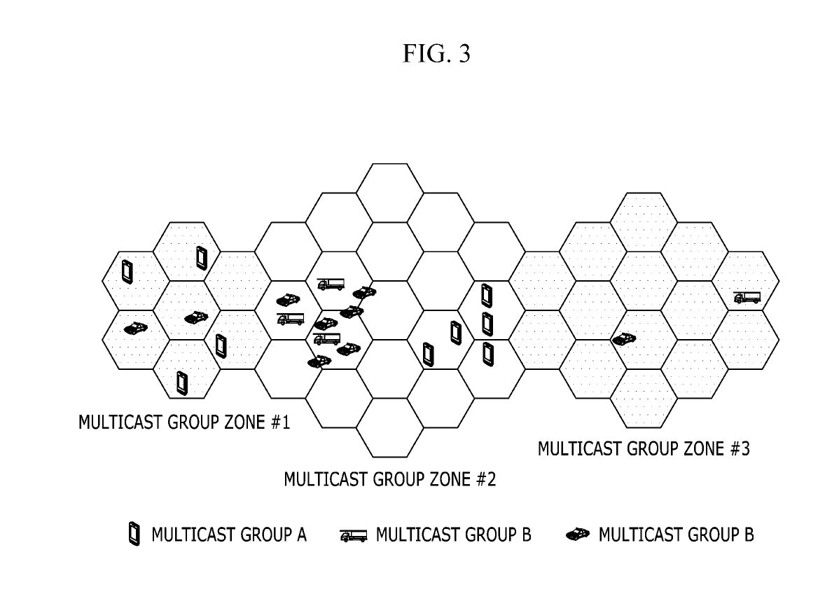

FIG. 3 shows a multicast communication system according to yet another embodiment of the present invention.

Referring to FIG. 3, a multicast group zone is defined as a set of base stations including at least one base station in a group communication system according to an embodiment of the present invention. A unique multicast group zone ID is allocated to the multicast group zone. In the multicast group zone, base stations use the same multicast group ID and FID (see an embodiment of FIG. 1) or the same multicast group CID (see an embodiment of FIG. 2) for transmitting data of a certain service flow. Accordingly, if a mobile station has already registered with a base station for a multicast service, the mobile station can be seamlessly receive the multicast service without reregistering with other base station even if the mobile station moves to the other base station within the same multicast group zone. If the mobile station moves from a base station to another base station, where those base stations provide the same multicast service but they belong to different multicast group zone, the mobile station can seamlessly receive the multicast service by updating a service flow parameter.

If only one base station belong to a multicast group zone, the single base station uses a multicast group CID for providing a multicast service, independently from other base stations.

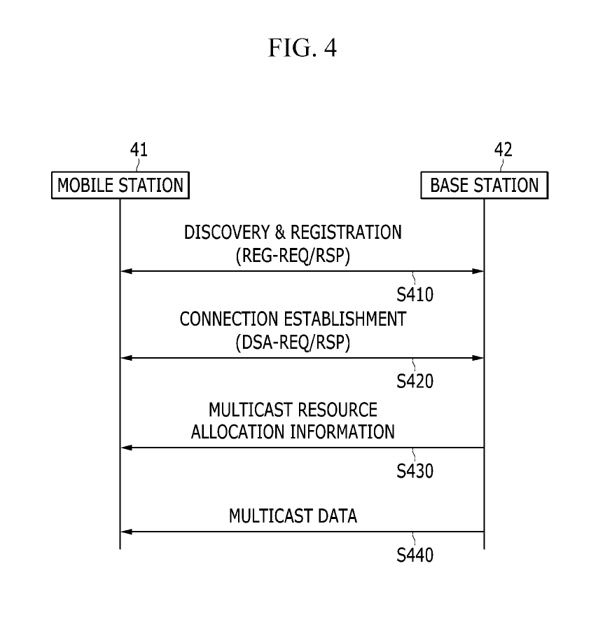

FIG. 4 shows a multicast connection establishment method according to an embodiment of the present invention.

Referring to FIG. 4, a mobile station 41 transmits a registration request (REG-REQ) message and a base station 42 transmits a registration response (REG-RSP) message to the mobile station 41 in response to the REG-REQ message (S410). To discover a multicast service, the mobile station 41 informs the base station 42 of support of multicast transmission by the REG-REQ message base station 42 and the base station 42 register the mobile station 41 by the REG-RSP message.

When the mobile station 41 registers to receive the multicast service, any one node of the mobile station 41 and the base station 42 initiates a dynamic service addition (DSA) procedure for a multicast connection service (S420). The one node of the mobile station 41 and the base station 42 transmits a DSA-REQ message to the other node and receives a DSA-RSP message from the other node such that the multicast connection is established.

The DSA-REQ and DSA-RSP messages include a multicast parameter associated with the multicast service. The multicast parameter includes a multicast group ID or a multicast group CID of a multicast group to which a service flow is added. When the multicast parameter includes the multicast group ID, the multicast parameter may further include a FID associated with the multicast group ID.

Further, when a multicast group zone is supported, the multicast parameter may further include a multicast group zone ID where the service flow is valid. The mobile station 41 can add the service flow for starting a multicast service by the multicast parameter. Alternatively, when the multicast group zones are not locally overlapped and are separated, the base station may periodically broadcast a multicast group zone ID through a broadcast message. In this case, the multicast parameter may not include the multicast group zone ID.

The mobile station 41 and the base station 42 may exchange a multicast service capability in the REQ-REQ/RSP exchange procedure (S410) or the DSA-REQ/RSP exchange procedure (S420).

As shown in Table 1, the multicast service capability may indicate at least one of no available multicast service, a multicast in a serving base station only, or a multicast in a multi base station zone supporting. For example, if the mobile station 41 or the base station 42 selects a desired multicast service capability in Table 1 and transmits the DSA-REQ message, an opponent node may transmit the multicast service capability for indicating an accept of a request or a denial of the request.

TABLE 1

| Length | Value |
|---|---|
| 1 | 0: No available multicast service |
| | 1: Multicast in Serving BS Only |
| | 2: Multicast in a multi-BS Zone supporting |
| | 3-255: Reserved |

As such, after establishing the service flow, the mobile station 41 receives a downlink control channel including allocation information of multicast resource from the base station 42 (S430), and receives multicast data from the base station 42 through the allocated resource (S440).

When a change of the service flow is required in the multicast service, the mobile station 41 and the base station 42 may perform a dynamic service change (DSC) procedure. That is, any one node of the mobile station 41 and the base station 42 transmits a DSC-REQ message, and the other node responds as a DSC-RSP message. The DSC-REQ message and the DSC-RSP message include a multicast parameter. The multicast parameter may include a current multicast group CID and a new multicast group CID, or current multicast group ID and FID and new multicast group ID and FID. The multicast parameter may further include a new multicast group zone ID.

When the multicast service is terminated, the mobile station 41 and the base station 42 may perform a dynamic service delete (DSD) procedure to delete the service flow. In this case, the multicast service of the multicast group may be terminated using the multicast group ID or the multicast group CID in the DSD procedure. The base station may terminate the multicast service using the multicast group zone ID in the DSD procedure. Any one node of the mobile station 41 and the base station 42 transmits a DSD-REQ message, and the other node responds as a DSD-RSP message.

The mobile station 41 may perform a system configuration procedure independently from the multicast connection establishment method according to an embodiment of the present invention. For a system configuration, the base station 42 periodically transmits a system configuration descriptor (SCD) message, and the mobile station 41 receives the SCD message to check the system configuration applied to a serving base station 42. The SCD message may include the multicast group zone ID for informing a current multicast group zone to which the base station 42 belongs.

The multicast connection establishment method according to an embodiment of the present invention may be applicable to a direct communication between terminals. In this case, the DSA-REQ and DSA-RSP messages may include information on a direct communication area.

As described above, according to an embodiment of the present invention, a mobile station and a base station can identify a supported multicast service through an exchange of a multicast service capability, and add, change or delete a service flow for the multicast service through a DSx (DSA, DSC, or DSD) procedure.

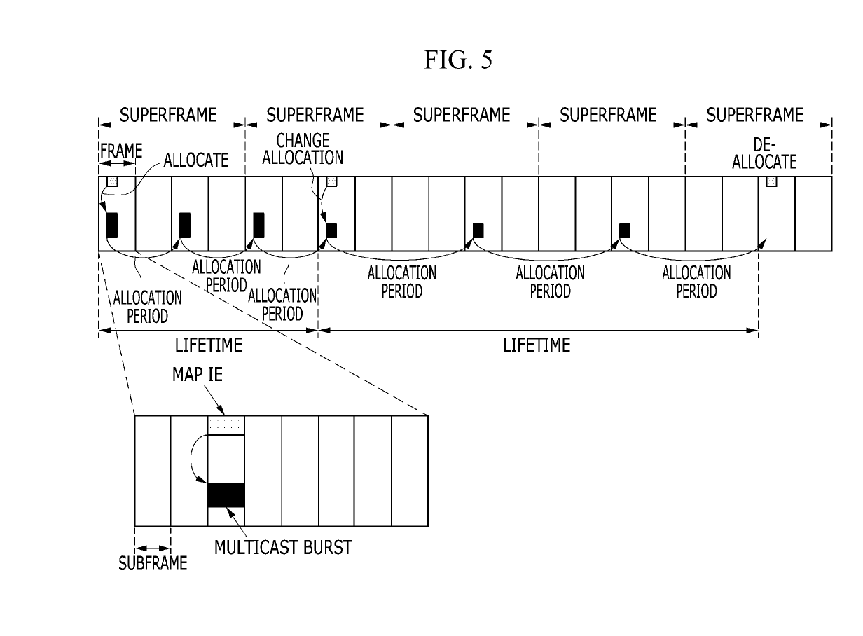

Next, a downlink control channel including allocation information of multicast resource will be described with reference to FIG. 5.

FIG. 5 shows an allocation method of multicast resource d according to an embodiment of the present invention.

A base station persistently allocates a multicast resource to a multicast group for a multicast communication, and a downlink control channel including allocation information of multicast resource. The downlink control channel may be a MAP information element (IE). For the multicast resource allocation, a new MAP IE may be defined. For example, the new MAP IE may be an HR-Multicast DL MAP IE (high reliability multicast downlink MAP IE) or an HR Multicast DL Assignment A-MAP IE that is a new type of A-MAP (advance MAP).

As shown in FIG. 5, the base station periodically (i.e., persistently) allocates the multicast resource at an interval of predetermined frames. The interval of predetermined frames corresponds to an allocation period. A plurality of frames, for example four frames may form one superframe, and one frame may include a plurality of subframes, for example eight subframes. In this case, the base station may transmit the MAP IE at a subframe to which the multicast resource is allocated.

The MAP IE includes multicast resource information allocated for the multicast communication, the allocation period, and a lifetime. The lifetime indicates a period in which a persistent allocation is maintained, and the resource allocation information does not change until the lifetime expires. If the lifetime expires, the base station allocates a persistent resource for the multicast communication again or releases the previously allocated resource, and transmits the MAP IE including relevant information. The base station may transmit a next MAP IE at a frame whose frame number N_{frame} satisfies Equation 1, or may transmit the next MAP IE at a superframe whose superframe number N_{superframe} satisfies Equation 2.

N_{frame} modulo L+1=0 (1)

N_{superframe} modulo L+1=0 (2)

In Equations 1 and 2, L indicates the lifetime.

Since the terminal can acquire information on the persistently allocated resource by only one decoding on the MAP IE, a power loss that occurs when decoding the MAP IE can be reduced. Further, the terminal can know a period in which the MAP IE is transmitted or a period in which a multicast burst is transmitted in advance such that the terminal can efficiently perform a power saving when entering a power saving mode such as a sleep mode or an idle mode. Furthermore, since the terminal can know a time for decoding a new MAP IE by the lifetime included in the current MAP IE, the terminal can check a change of the persistently allocated resource.

The MAP IE may further include information on a multicast connection, for example a multicast group CID such that the terminal can identify the MAP IE.

Alternatively, the base station may generate 16-bit cyclic redundancy check (CRC) based on the randomized sequence of information bits of the MAP IE. Further, the base station may mask the 16-bit CRC by a CRC mask including a multicast group ID, and attach the masked CRC to the MAP IE. The terminal can identify the MAP IE using the CRC mask including the multicast group ID to which it belongs.

An example of FIG. 5 shows that the multicast resource is persistently allocated with the allocation period of 2 and the lifetime of 6, the multicast resource is persistently allocated with the allocation period of 4 and the lifetime of 12, and then the allocated resource is released.

Next, an embodiment for performing an uplink communication in a multicast communication will be described.

A base station transmits a multicast assignment request (MCA-REQ) message to a mobile station to be allocated to a multicast polling group or to be deleted from the multicast polling group. The mobile station transmits an MCA response (MCA-RSP) message to the base station in response to the MCA-REQ message. The MCA-REQ message and the MCA-RSP message may include a multicast group ID or a multicast group CID. The MCA-REQ message and the MCA-RSP message may further include an allocation ID indicating a join of the multicast polling group or a leave of the multicast polling group.

By the multicast polling process, the mobile station within the multicast group can be selected as a talker that can transmit an uplink multicast burst to other mobile stations within the multicast group. Alternatively, the mobile station may initiate an operation of the talker by a random access process. At this time, the base station may use a reduced CID (RCID) defined in IEEE 802.16-2009 or define a priority level to select a mobile station for the talker. The talker mobile station may stop the operation of the talker when a signal indicating a stop is received or a predetermined timer expires.

Further, a talker mobile station may be selected by the random access process or a direct communication establishment process in a direct communication mode between mobile stations.

Furthermore, the mobile station may invite other mobile station to the multicast group to reconfigure the multicast group by the DSA or DSC procedure, and may delete other mobile station from the multicast group by the DSD procedure. The DSA, DSC, or DSD procedure may be applicable to the direct communication mode.

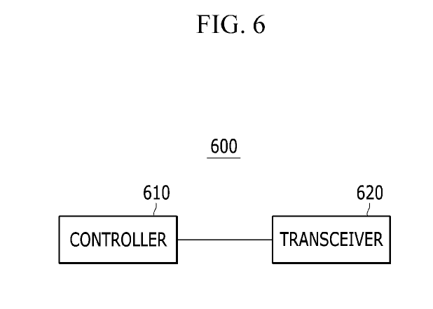

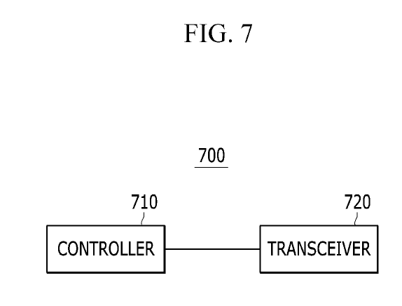

Next, a multicast connection establishment apparatus for performing an multicast connection establishment method according to an embodiment of the present invention will be described with reference to FIG. 6 and FIG. 7.

FIG. 6 and FIG. 7 each are a block diagram of a multicast connection establishment apparatus according to an embodiment of the present invention.

Referring to FIG. 6, a multicast connection establishment apparatus 600 includes a controller 610 and a transceiver 620. The multicast connection establishment apparatus 600 of FIG. 6 may be included in a mobile station or may be the mobile station.

The controller 610 generates a REG-REQ message for a discovery of a multicast service. The transceiver 620 transmits the REG-REQ message to a base station, and receives a REG-RSP message from the base station in response to the REG-REQ message. The controller 610 generates a DSA-REQ message to add a service flow for the multicast service. The transceiver 620 transmits the DSA-REQ message to the base station, and receives a DSA-RSP message from the base station in response to the DSA-REQ message. Alternatively, the transceiver 620 may receive the DSA-REQ message from the base station. The controller 610 may generate the DSA-RSP message in response to the DSA-REQ message, and the transceiver 620 may transmit the DSA-RSP message to the base station. Further, the transceiver 620 receives a downlink control channel including allocation information of multicast resource from the base station, and receives multicast data through the allocated resource.

The DSA-REQ and DSA-RSP messages may include a multicast parameter as described above. The REG-REQ/RSP message or DSA-REQ/RSP message may include a multicast service capability shown in Table 1.

Further, for a change or delete of the service flow, the controller 610 may generate a DSC-REQ/RSP or DSD-REQ/RSP message, and the transceiver 620 may transmit or receive the DSC-REQ/RSP or DSD-REQ/RSP message.

Referring to FIG. 7, a multicast connection establishment apparatus 700 includes a controller 710 and a transceiver 720. The multicast connection establishment apparatus 700 of FIG. 7 may be included in a base station or may be the base station.

The transceiver 720 receives a REG-REQ message for a discovery of a multicast service from a mobile station. The controller 710 generates a REG-RSP message in response to the REG-REQ message, and the transceiver 720 transmits the REG-RSP message to the mobile station. The controller 710 generates a DSA-REQ message for an addition of a service flow for the multicast service. The transceiver 720 transmits the DSA-REQ message to the mobile station, and receives a DSA-RSP message from the mobile station in response to the DSA-REQ message. Alternatively, the transceiver 720 may receive the DSA-REQ message from the mobile station. The controller 710 may generate the DSA-RSP message in response to the DSA-REQ message, and the transceiver 720 may transmit the DSA-RSP message to the mobile station. Further, the controller 710 allocates a multicast resource for the multicast service, and the transceiver 720 transmits a downlink control channel including allocation information of multicast resource to the mobile station. The transceiver 720 transmits multicast data to the mobile station through the allocated resource.

The DSA-REQ and DSA-RSP messages may include a multicast parameter as described above. The REG-REQ/RSP message or DSA-REQ/RSP message may include a multicast service capability shown in Table 1.

Further, for a change or delete of the service flow, the controller 710 may generate a DSC-REQ/RSP or DSD-REQ/RSP message, and the transceiver 720 may transmit or receive the DSC-REQ/RSP or DSD-REQ/RSP message.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method of establishing a multicast connection with a base station in a mobile station, the method comprising:
transmitting a registration request message for a discovery of a multicast service to the base station;
receiving a registration response message from the base station in response to the registration request message;
exchanging a dynamic service addition (DSA) request message and a DSA response message to the DSA request message with the base station, for a multicast connection on the multicast service; and
receiving a downlink control channel including allocation information of multicast resource from the base station.

2. The method of claim 1, wherein each of the DSA request message and the DSA response message includes a multicast parameter, and
wherein the multicast parameter includes a multicast group ID to which a service flow on the multicast service is added and a flow ID (FID) for identifying the service flow in the multicast group.

3. The method of claim 2, wherein the multicast parameter further includes a multicast group zone ID where the service flow is valid, and
wherein the multicast group zone includes a base station set including at least one base station, and each of the multicast group ID and the FID for the service flow has the same value in the base station set.

4. The method of claim 3, further comprising exchanging a dynamic service change (DSC) request message and a DSC response message to the DSC request message with the base station, for a change of the service flow,
wherein each of the DSC request message and the DSC response message includes a new multicast group zone ID, current multicast group ID and FID, and new multicast group ID and FID.

5. The method of claim 1, wherein each of the DSA request message and the DSA response message includes a multicast parameter, and
wherein the multicast parameter includes a multicast group connection identifier (CID) for identifying a service flow on the multicast service.

6. The method of claim 5, wherein the multicast parameter further includes a multicast group zone ID where the service flow is valid, and
wherein the multicast group zone includes a base station set including at least one base station, and the multicast group CID for the service flow has the same value in the base station set.

7. The method of claim 6, further comprising exchanging a DSC request message and a DSC response message to the DSC request message with the base station, for a change of the service flow,
wherein each of the DSC request message and the DSC response message includes a new multicast group zone ID, a current multicast group CID, and a new multicast group CID.

8. The method of claim 1, wherein each of the DSA request message and the DSA response message includes a multicast service capability, and
wherein the multicast service capability indicates at least one of no available multicast service, a multicast in a serving base station only, or a multicast in a multi base station zone supporting.

9. The method of claim 1, wherein each of the registration request message and the registration response message includes a multicast service capability, and
wherein the multicast service capability indicates at least one of no available multicast service, a multicast in a serving base station only, or a multicast in a multi base station zone supporting.

10. A method of establishing a multicast connection with a mobile station in a base station, the method comprising:
receiving a registration request message for a discovery of a multicast service from the mobile station;
transmitting a registration response message to the mobile station in response to the registration request message;
exchanging a DSA request message and a DSA response message to the DSA request message with the mobile station, for a multicast connection on the multicast service; and
transmitting a downlink control channel including allocation information of multicast resource to the mobile station.

11. The method of claim 10, wherein each of the DSA request message and the DSA response message includes a multicast parameter, and
wherein the multicast parameter includes a multicast group ID to which a service flow on the multicast service is added and a FID for identifying the service flow in the multicast group.

12. The method of claim 11, wherein the multicast parameter further includes a multicast group zone ID where the service flow is valid, and
wherein the multicast group zone includes a base station set including at least one base station, and each of the multicast group ID and the FID for the service flow has the same value in the base station set.

13. The method of claim 12, further comprising exchanging a DSC request message and a DSC response message to the DSC request message with the mobile station, for a change of the service flow,
wherein each of the DSC request message and the DSC response message includes a new multicast group zone ID, current multicast group ID and FID, and new multicast group ID and FID.

14. The method of claim 10, wherein each of the DSA request message and the DSA response message includes a multicast parameter, and
wherein the multicast parameter includes a multicast group CID for identifying a service flow on the multicast service.

15. The method of claim 14, wherein the multicast parameter further includes a multicast group zone ID where the service flow is valid, and
wherein the multicast group zone includes a base station set including at least one base station, and the multicast group CID for the service flow has the same value in the base station set.

16. The method of claim 15, further comprising exchanging a DSC request message and a DSC response message to the DSC request message with the mobile station, for a change of the service flow,
wherein each of the DSC request message and the DSC response message includes a new multicast group zone ID, a current multicast group CID, and a new multicast group CID.

17. The method of claim 10, wherein each of the DSA request message and the DSA response message includes a multicast service capability, and
wherein the multicast service capability indicates at least one of no available multicast service, a multicast in a serving base station only, or a multicast in a multi base station zone supporting.

18. The method of claim 10, wherein each of the registration request message and the registration response message includes a multicast service capability, and
wherein the multicast service capability indicates at least one of no available multicast service, a multicast in a serving base station only, or a multicast in a multi base station zone supporting.

19. An apparatus for establishing a multicast connection, the apparatus comprising:
a transceiver configured to transmit a registration request message for a discovery of a multicast service to a base station, receive a registration response message from the base station in response to the registration request message, exchange a DSA request message and a DSA response message to the DSA request message with the base station for a multicast connection on the multicast service, and receive a downlink control channel including allocation information of multicast resource from the base station; and
a controller configured to generate the registration request message and the DSA request message or the DSA response message.

20. An apparatus for establishing a multicast connection, the apparatus comprising:
a transceiver configured to receive a registration request message for a discovery of a multicast service from a mobile station, transmit a registration response message to the mobile station in response to the registration request message, exchange a DSA request message and a DSA response message to the DSA request message with the mobile station, for a multicast connection on the multicast service, and transmit a downlink control channel including allocation information of multicast resource to the mobile station; and
a controller configured to generate the registration response message and the DSA request message or the DSA response message.
